(19) United States
(12) Patent Application Publication
(10) Pub. No.: US 2005/0023295 A1
(43) Pub. Date: Feb. 3, 2005

(54) Dosing device with an application top

(76) Inventor: Karl Tempfli, Gottmadingen (DE)

Correspondence Address: FLYNN THIEL BOUTELL & TANIS, P.C., 2026 RAMBLING ROAD, KALAMAZOO, MI, 49008-1699, US

(21) Appl. No.: 10/902,517

(22) Filed: Jul. 29, 2004

(30) Foreign Application Priority Data
Aug. 1, 2003 (DE) 10336293.2

(51) Int. Cl. B67D 5/52

(52) U.S. Cl. 222/135; 222/321.9; 222/478

(57) ABSTRACT

Dosing device with application rounded cone or top. A dosing device with an application top containing at least one application opening, as well as a supply device which, when operating, leads a first medium through at least one medium channel from a medium reservoir to the application opening is known. According to the invention, at least one discharge opening for at least one further medium is provided in the application top adjacent to the application opening and within the application top at least one flow channel for the at least one further medium leads to the discharge opening.

The following disclosure is based on German Patent Application No. 10336293.2 filed on Aug. 1, 2003, which is herewith incorporated into this application by explicit reference.

### BACKGROUND FOR THE INVENTION

The invention relates to a dosing device with an application rounded cone or top in which there is at least one application opening, as well as with a supply device which, when functioning, guides a first medium through at least one medium channel from a medium reservoir to the application opening.

Numerous different designs of such dosing devices are known from the prior art. They are more particularly used for dosing liquid, gaseous or pulverulent media and in particular allow the supply of such media to body orifices for medical and therapeutic purposes. To this end on the dosing device is provided an application top, which has a particularly slender contour, which is rounded in its front end region. The application top with the rounded contour can be introduced into a body orifice. The application top has at least one application opening, through which the pressurized medium to be dosed can be delivered into an environment. An application opening can in particular be in the form of a bore or hole with a bore or hole cross-section matched to the medium in the application top. The cross-section of the hole significantly influences the dosing of the medium, because on passing out of the application opening the pressurized medium is expanded in a virtually shock-like manner to ambient pressure. As a function of the pressure gradient in the hole cross-section as well as a nozzle effect through the same, during dosing the medium is expanded to a greater or lesser extent and atomized as a function thereof. The cross-section of the hole can in particular be cylindrical, conical, hyperbolic or spherical, or alternatively a combination thereof.

A supply device pressurizes the medium which is delivered through the application opening. The supply device is in particular constructed as a pressure reservoir or pressure generating device. In the case of a pressure reservoir the medium is subject to a static overpressure, which permits a discharge of the medium through the application opening into the environment. A pressure generating device can in particular be constructed as a manually operable pumping device, in which the medium is pressurized by the operating force of a user and in this way is discharged through the application opening into the environment.

The medium is stored in a medium reservoir, which is either fixedly associated with the dosing device or can be added as a separate component. For conveying the medium to the application opening a medium channel is provided in the application top and leads from the medium reservoir to the application opening. The medium channel can in particular be connected in one piece to the application top. It would also be conceivable to have a separate medium channel with a fastening area with respect to the application top. When the supply device is operating, the medium is led from the medium reservoir to the application opening and as a result of a pressure difference between the medium and the environment it is in particular sprayed, atomized or released.

The problem of the invention is to provide a dosing device of the aforementioned type leading to improved dosing.

This problem is solved in that at least one discharge opening for at least one further medium is located in the application top adjacent to the application opening and that within the application top at least one flow channel for the at least one further medium leads to the discharge opening. The discharge opening can in particular be designed like an application opening. It is also possible to have a random profiling, such as in particular as an annular portion, circular segment, radial or oval opening. The at least one further medium can in particular be liquid, gaseous, pulverulent or a mixture of media in different states of aggregation. The at least one discharge opening for the at least one further medium is located in the application top adjacent to the application opening. A discharge direction as well as a discharge contour for the at least one further medium can be matched to the first medium in such a way that said first medium is in particular accelerated, deflected, enveloped or distributed by the at least one further medium. For this purpose the application top has at least one flow channel, which leads at least one further medium to the discharge opening and consequently more particularly allows a synchronous discharge of the first medium and the at least one further medium. The flow channel can in particular be in the form of a separate component in the application top or can be bounded by a suitable arrangement of the medium channel in the application top. Preferably the application top is constructed as a nose olive and the further medium is air, which aids a liquid, first medium during application to the nose.

According to a development of the invention the discharge opening is provided on a front end region of the application top. For using the dosing device according to the invention in body orifices, it is in particular provided that both the first medium to be dosed and also the at least one further medium, are discharged more particularly linearly or conically in the direction of a principal axis of the application top. Through the provision of the at least one discharge opening on a front end region of the application top, such a discharge of the media can be ensured. In a preferred embodiment the discharge directions of the discharge openings are symmetrical to an application direction of the application opening.

According to a further development of the invention the discharge opening is concentric to the application opening. In the case of a concentric arrangement of the at least one discharge opening with respect to the application opening, this leads to a particularly advantageous interaction between the first medium and the at least one further medium during the dosing process, because the at least one further medium at least partly surrounds the first medium in jacket-like manner and can consequently have a guidance function for the first medium. A discharge opening provided concentrically to the application opening can in particular be annular or zonally annular with a rectangular, conical, hyperbolic or spherical cross-section or can be in the form of a combination thereof.

According to a further development of the invention there are several discharge openings arranged in circular manner around the application opening. A circular arrangement of the discharge openings more particularly makes it possible to utilize advantages of concentric arrangements with the additional possibility of obtaining a jet formation through the action of the discharged media as a result of the different cross-sections and/or profiles of the discharge openings. The discharge openings can be located on one or more circles or circular segments arranged concentrically to the application opening, it being possible to match the discharge directions to the desired discharged contour of the first medium. In a preferred embodiment a plurality of discharge openings is provided on a single circle arranged concentrically to the application opening, where all the discharge openings have an identical cross-section and an identical discharge direction.

Further advantages and features of the invention can be gathered from the following description of a preferred embodiment, the claims and the attached drawings, wherein show:

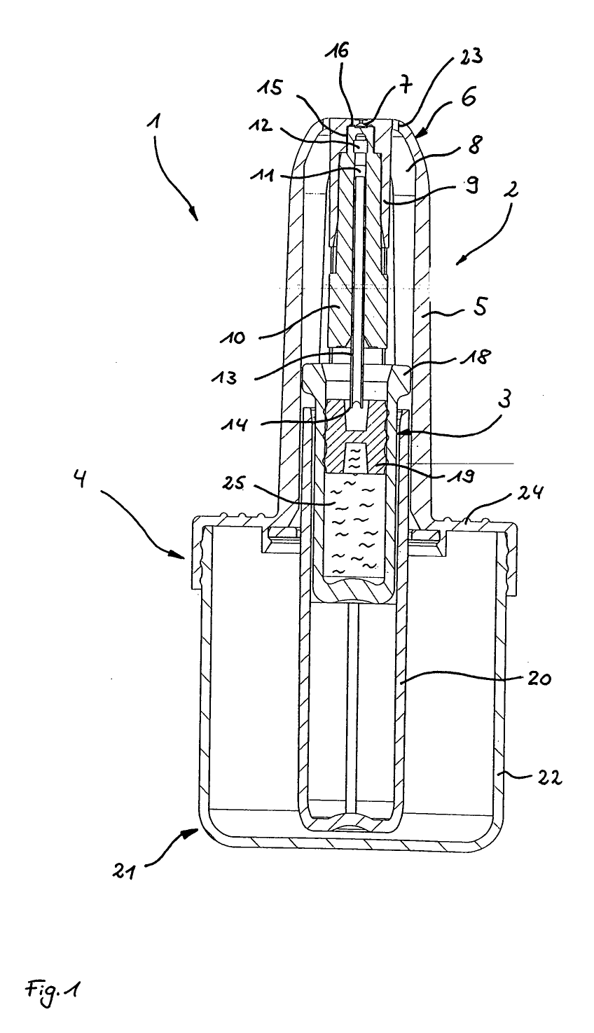

FIG. 1 In a planar sectional representation a dosing device with an application top, supply device and medium reservoir.

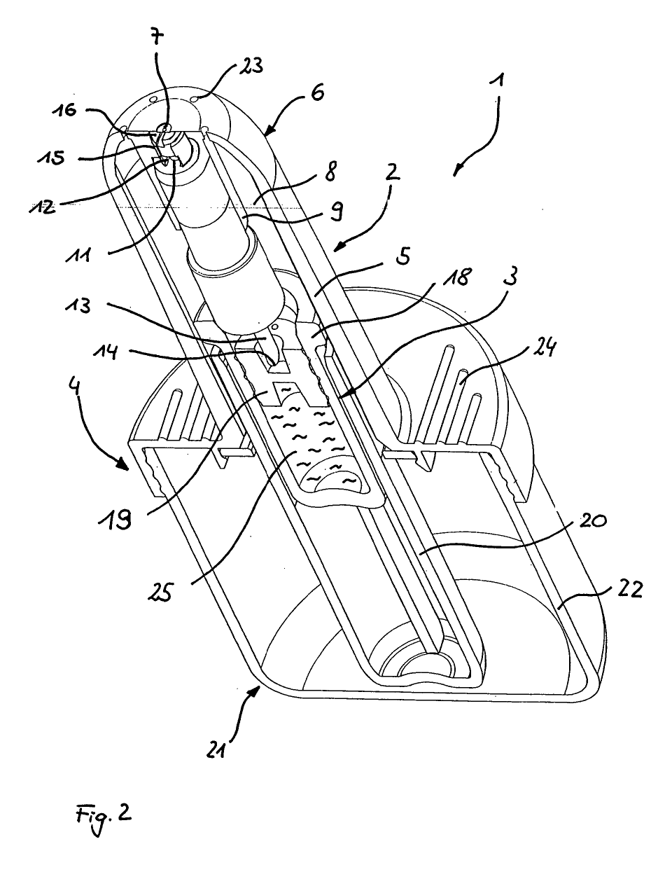

FIG. 2 In an isometric sectional representation a dosing device according to FIG. 1.

A dosing device 1 has an applicator 2, a manually operable dosing pump 3 constructed as a supply device and a handle 4. The dosing pump 3 is designed for a single actuation, i.e. it is required for a single application or administration, there only being one pump stroke. The applicator 2 has a nose olive 5 constructed as an application top or rounded cone and which is constructed in the form of a slender sleeve. In a frontally closed end region 6 the nose olive 5 has an application opening 7, which is rotationally symmetrical to a median longitudinal axis of the nose olive 5. A guide bush 9 projects from the end region 6 into an inner area 8 surrounded by the nose olive 5. The guide bush 9 has a rotationally symmetrical construction and is provided with a substantially cylindrical outer contour, together with a cylindrically stepped inner contour, which is conically designed in an end region for receiving a filler 10. The filler 10 is non-positively pressed into the guide bush 9 and has an inner hole or bore 11 concentric to the median longitudinal axis, as well as a cross-hole 12 positioned orthogonally to the median longitudinal axis. A tube portion 13 is pressed positively into the inner hole 11 and has on an end remote from the application opening a sloping cutting edge 14. Together with the inner hole 11 and cross-hole 12, the tube portion 13 forms part of a medium channel extending from the cutting edge 14 to the application opening 7.

In an area between the cross-hole 12 and the application opening 7, the medium channel is formed by a cylindrical gap 15 and a sealing disk surface 16, which is implemented by the guide bush 9 being spaced from the filler 10. Whereas the guide bush 9 and filler 10 in the vicinity of the sealing disk surface 16 in a rest position at least zonally sealingly engage flat on one another, an end face of the guide bush 9, which also contains the application opening 7, is deformed when the medium pressure in the medium channel rises. As a result the sealing action between the guide bush 9 and filler 10 is temporarily cancelled out and the medium can be delivered into the environment through the medium channel and the application opening 7.

In the end region 6, the inner area 8 of the nose olive 5 is connected in communicating manner with the environment by discharge openings in the form of axial holes 17. Through the arrangement of the guide bush 9 and filler 10 in the nose olive 5, the inner area 8 is at least zonally provided as a flow channel for at least one further medium. On an end of the filler 10 remote from the application opening 7 is provided a medium reservoir 18 guided in the vicinity of the nose olive 5 and which in the rest state is closed by a sealing plug 19. The medium reservoir 18 is at least zonally surrounded by a pressure sleeve 20, which is also zonally guided in the nose olive 5. For a force transfer between the pressure sleeve 20 and medium reservoir 18, on the latter is provided a circumferential collar with which can be positively contacted an end face of the pressure sleeve 20. On an actuating area 21 remote from the end region 6 of nose olive 5, the pressure sleeve 20 is surrounded by a flexible pressure bellows 22, which defines with the applicator 2 an outer contour of the dosing device 1. The pressure bellows 22 encloses an air volume, which can be delivered to the environment through the discharge openings 23 during a dosing process through the inner area 8 of the nose olive 5 constructed as a flow channel.

For a dosing process of the dosing device 1, a user places at least two fingers, particularly the middle and index fingers on a bearing surface 24 of the applicator 2. An actuating force is exerted on the actuating area 21 using another finger, particularly the thumb. As a result of the actuating force the pressure bellows 22 is deformed until it engages with the pressure sleeve 20. The pressure sleeve 20 is then displaced in the direction of the end region 6 until at a front end it positively contacts the circumferential collar of the medium reservoir 18. The pressure sleeve 20 is then displaced further in the direction of the end region 6 synchronously with the medium reservoir 18 until the cutting edge 14 of the tube portion 13 strikes the surface of the sealing plug 19 constructed as a perforation membrane. As a result of the bevel of the cutting edge 14 of tube portion 13, it is possible in the case of a corresponding actuating force to perforate the perforation membrane of the sealing plug 19, so that a medium 25 enclosed in the medium reservoir comes into communicating connection with the medium channel.

By further exerting the actuating force on the actuating area 21 of the dosing device 1, the pressure sleeve 20 and medium reservoir 18 are moved further in the direction of the end region 6 and in the medium reservoir a pressure buildup occurs as soon as a front side of the filler 10 runs up onto the sealing plug 19 constructed as a pump piston and moves the same in the direction of the enclosed medium 25. As a result the medium 25 is pressed into the medium channel and flows along the tube portion 13 into the inner hole 11 and then into the cross-hole 12, together with the cylindrical gap 15 following onto the latter. As soon as a corresponding pressure buildup has taken place, the guide bush 9 is deformed, so that the sealing disk surface 16 passes out of its sealing position into a flow position and permits a medium flow through the application opening 7. As a result of the geometry of the application opening 7 and the overpressure of the medium an atomization of the latter occurs and fine medium particles are delivered into the environment by the dosing device 1 at a pressure-dependent discharge speed. As simultaneously and synchronously with the movement of the pressure sleeve 20 there is a deformation of the pressure bellows 22, at the same time as the medium, the air enclosed by said pressure bellows 22 flows along the inner area 8 of the nose olive 5 through the discharge openings 23 into the environment and forms a jacket flow for the medium, which is discharged from the medium reservoir 18. The jacket flow also ensures a greater dosage range into the body orifice, so that for therapeutic applications a smaller medium quantity can be provided in order to bring about the same result as in the case of prior art dosing devices.

In another, not shown embodiment of the invention the single action pump is replaced by a multiple pumping system in the form of the supply device. In the case of a multiple pumping system a pump piston is moved in known manner by a plunger in a pump casing. As a result a first medium quantity can be delivered from the medium reservoir. The at least one further medium can also be delivered from a medium reservoir by a parallel-connected, further multiple pumping system. When using ambient air as the further medium, there can be a delivery through the further multiple pumping system directly from the environment.

In another, also not shown embodiment, at least one medium is stored in a pressurized medium reservoir closed by a perforation membrane or a valve and which can be opened for dosing purposes. A pressurized medium reservoir, particularly in the case of a gaseous medium, can be implemented by compressed storage of the medium. Propellant-filled medium reservoirs are known for liquid media.

In a further, not shown embodiment of the invention, the at least one further medium is placed under pressure by an exhalation movement on the part of the user and supplied to the dosing device. The user holds a mouthpiece sealingly embraced by the lips, so that there is an overpressure at the mouthpiece during the exhalation movement. By means of a flow channel, which can in particular be in hose form, said overpressure is supplied to the inner area of the nose olive and consequently brings about the desired flow-round of the first medium through the discharge openings. There is preferably a synchronization of the dosage of the first medium with the exhalation movement by the provision of synchronizing means.

1. Dosing device with an application top (5) containing at least one application opening (7), as well as with a supply device (3) which, when operating, guides a first medium (25) through at least one medium channel (11, 12, 13, 15, 16) from a medium reservoir (18) to the application opening (7), wherein at least one discharge opening (23) for at least one further medium is provided in the application top (5) adjacent to the application opening (7) and wherein within the application top (5) at least one flow channel (8) for the at least one further medium leads to the discharge opening (23).

2. Dosing device according to claim 1, wherein the discharge opening (23) is provided on a front end region (6) of the application top (5).

3. Dosing device according to claim 1, wherein the discharge opening (23) is positioned concentrically to the application opening (7).

4. Dosing device according to claim 1., wherein several discharge openings (23) are provided in circular manner around the application opening (7).
